(19) United States
(12) Patent Application Publication
(10) Pub. No.: US 2010/0154290 A1
(43) Pub. Date: Jun. 24, 2010

(54) ATTRACT AND KILL PEST CONTROL DEVICE

(76) Inventor: Joan Fisher, Bend, OR (US)

Correspondence Address: DALINA PASADENA, 117 E. Colorado Blvd., Suite 460, Pasadena, CA, 91105, US

(21) Appl. No.: 12/538,289

(22) Filed: Aug. 10, 2009

Related U.S. Application Data
(63) Continuation-in-part of application No. 12/342,611, filed on Dec. 23, 2008.

(51) Int. Cl. A01M 1/00; A01M 1/20; A01M 1/14; A01M 1/02; A01M 1/10

(52) U.S. Cl. 43/114; 43/131; 43/107

(57) ABSTRACT

The present invention provides for an attack and kill pest control device. A chamber of the attack and kill pest control device comprises a chamber wall with a plurality of vent openings. The chamber is configured to receive a lure comprising a volatile semiochemical attractant. The plurality of vent openings is configured allow airflow through the chamber wall, releasing the volatile semiochemical attractant. A pesticide layer is affixed to a surface of a treated portion of the chamber wall.

This application is a continuation in part of U.S. patent application Ser. No. 12/342,611, filed Dec. 23, 2008 entitled “Easily Disassembled Navel Orangeworm Egg Trap Apparatus,” the specification of which is incorporated herein by reference.

### BACKGROUND OF THE INVENTION

1. Field of the Invention

Embodiments of the invention described herein pertain to the field of pest management. More particularly, but not by way of limitation, one or more embodiments of the invention are directed to a device that is utilized to attract and kill pests.

2. Description of the Related Art

The codling moth is a common agricultural pest found worldwide. The larval stage of the codling moth is the common apple worm, but the pest also attacks other tree fruits, including walnuts. The female codling moth lays eggs on the surface of fruits and leaves. Upon hatching, the larvae immediately burrow into the fruit. The larvae feed inside the fruit for approximately 3 weeks before emerging to pupate elsewhere. Codling moth larvae can create holes in walnut hulls. Because navel orangeworm can only attack nuts with damaged or split husks or shells, proper management of navel orangeworm includes controlling codling moth and other insects capable of boring through shells.

Insect traps and egg traps are used to monitor insect pest populations. Pheromones are used in insect traps as an alternative to or in conjunction with other insect baits. Pheromones act as chemical signals between members of the same species. Pheromones are involved in navigation, social behavior and sexual behavior of insects. Some pheromones are sex specific, luring members of one sex. A conventional navel orangeworm egg trap typically is a narrow plastic vial filled with an ovipositional bait attractant. Codling moth population is typically monitored using liquid bait traps or female pheromone traps designed to attract male codling moths.

Female codling moth sex pheremone is used to monitor as well as to manage codling moth populations. When codling moth infestations are managed with pesticides, accurate treatment timing is important, since the larvae are often protected by the hull or shell. Therefore, monitoring codling moth population is a critical part of a management program. Pheromone traps are used to capture male moths to determine biofix, the time of first flight for codling moth. Biofix and weather data is used concurrently to determine when a population is most susceptible to pesticide treatment.

Mating disruption is another effective management strategy for controlling codling moth populations. Mating disruption is a technique designed to control certain insect infestations through the disruption of the insect's reproductive cycle. In the case of codling moth population management, female codling moth pheromone is applied in a sufficient concentration over the managed area. The occurrence of mating is substantially reduced. Mating disruption is generally used as an alternative or an adjunct to insecticides.

While these attractant based approaches do provide a basis for controlling the population of insects such approaches do not effectively terminate the insects. As such there is a need for a device that can both attract and then terminate the insects.

### BRIEF SUMMARY OF THE INVENTION

One or more embodiments of the invention are directed to a pest control device with a chamber wall comprising a plurality of vent openings which allow airflow through the chamber wall. The chamber of the pest control device is configured to receive a lure containing a volatile semiochemical attractant, such as a food-based attractant, an ovipositional attractant, a plant volatile, a pheromone, a kairomone, or any other semiochemical attractant. A pesticide layer is affixed to the surface of a treated portion of the chamber wall, wherein the treated portion includes at least one vent opening. The pesticide layer is affixed to the outer surface or both the inner and outer surfaces of the chamber wall. In one or more embodiments, the pesticide layer is affixed to the treated portion of the chamber wall with an adhesive layer. The pesticide layer may also be affixed directly to the treated portion of the chamber wall. The pesticide layer may comprise both an adhesive and a pesticide in a single pesticide layer.

In one or more embodiments, the vent openings are configured for omnidirectional release of the volatile semiochemical attractant. The lure comprises at least one semiochemical attractant directed toward at least one target insect pest. Suitable semiochemical attractants include ovipositional bait attractants and sex pheromones, such as a female sex pheromone which attracts the male codling moth. The shape, size, color and other visual characteristics of the pest control device are selected to attract a target insect pest species. In one or more embodiments, the pest control device has a hanger configured to support the pest control device from a physical structure. In the example described throughout the disclosure the pest control device chamber is cylindrical but can be configured in others shapes that provide reasonable airflow when the lure is placed within the chamber.

The pest control device is generally used as an insect population control and monitoring device. If desired the pest control device is usable as an insect egg trap as it contains surface topographies on an outer surface of the chamber wall which simulates an egg laying surface.

The device serves as a population management device and can be configured to target specific insects, such as the navel orangeworm and codling moth. In one or more instances the lure comprises a semiochemical attractant suitable for mating disruption in insect populations. The device may contain, for example, a pheromone such as the female codling moth sex pheromone. The device may also contain other pheromones that are utilized for attracting other insects.

The chamber wall of the device is composed of two or more chamber wall sections configured to couple detachably to form the chamber wall, thereby facilitating placing or replacing a lure, maintenance, cleaning, or inspection of collected target insect pests inside the chamber.

### BRIEF DESCRIPTION OF THE DRAWINGS

The above and other aspects, features and advantages of the invention will be more apparent from the following more particular description thereof, presented in conjunction with the following drawings wherein:

FIG. 1 presents a perspective view of an attract and kill pest control device in accordance with one or more embodiments.

FIG. 2 presents a side view of a chamber wall of a pest control device in accordance with one or more embodiments.

FIG. 3A presents a cross section view of a vent opening in a treated portion of a chamber wall in one or more embodiments, where the pesticide layer is affixed to both the inner and outer surfaces.

FIG. 3B presents a cross section view of a vent opening in a treated portion of a chamber wall in one or more embodiments, where the pesticide layer is affixed to the outer surface.

FIG. 4 presents a perspective view of an attract and kill pest control device with a chamber wall comprising two or more chamber wall sections in accordance with one or more embodiments.

### DETAILED DESCRIPTION

An attract and kill pest control device will now be described. In the following exemplary description, numerous specific details are set forth in order to provide a more thorough understanding of embodiments of the invention. It will be apparent, however, to one of ordinary skill in the art that the present invention may be practiced without incorporating all aspects of the specific details described herein. In other instances, specific features, quantities, or measurements well known to those of ordinary skill in the art have not been described in detail so as not to obscure the invention. Readers should note that, although examples of the invention are set forth herein, the claims, and the full scope of any equivalents, are what define the invention.

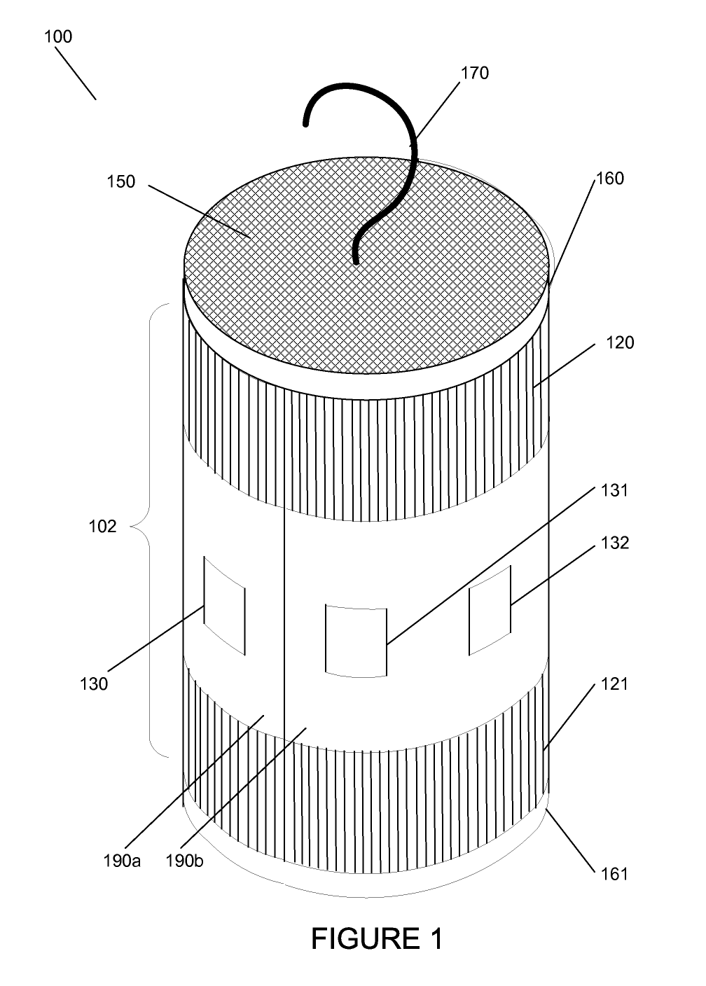

FIG. 1 presents a perspective view of an attract and kill pest control device. Pest control device 100 includes a chamber surrounded by chamber wall 102. The chamber is a radially symmetric shape, such as a cylinder or a sphere. The shape and/or the color of the chamber is selected to attract a target insect pest species. Optionally, the chamber is configured to collect target insect pests directly in the bottom of the chamber or in an additional structure inside or immediately below the chamber. For example, an additional collecting component may be coupled with said chamber to collect target insect pests affected by the pesticide layer to facilitate monitoring of the target insect pest species.

In one or more embodiments, the chamber of pest control device 100 is made of a single chamber wall section. Alternatively, chamber wall 102 comprises two or more chamber wall sections 190a and 190b. Chamber wall sections 190a and 190b are configured to couple thereby forming chamber wall 102 of pest control device 100. In one or more embodiments, chamber wall sections 190a-190b are flat, angular or curved sections which are configured to couple to form chamber wall 102 of pest control device 100. One or more chamber wall sections of chamber wall 102 are formed from a material such as plastic, metal, carbon fiber, cardboard, fiberglass, or any other durable material. One or more chamber wall sections of chamber wall 102 are formed through the means of an injection molding process, a machining or milling process, or through an assembly process.

In one or more embodiments, a lure containing a semiochemical attractant is placed inside the pest control device chamber. The lure may be designed to specifically attract a target insect pest species, such as the navel orangeworm or the codling moth. For example, the device described herein may utilize a lure that comprises a semiochemical attractant and a permeable membrane with a substantially constant release rate of the attractant over the life of the lure, such as the line of Biolure® products manufactured by Suterra®. In one or more embodiments, the device utilizes a lure designed to facilitate omnidirectional release of the volatile compounds in the attractant. For example, substantitally all outer surfaces of a specially designed lure comprises a permeable membrane such that the lure is configured to release volatile compounds from all outer surfaces of the lure. As used herein, the term “omnidirectional” refers to all directions radially extending from the vertical axis of pest control device 100. The attractant may make use of a pheromone used for mating disruption, such as female codling moth sex hormone.

Chamber wall 102 has a plurality of vent openings 130-132 that allow the volatile compounds in the attractant to permeate the surrounding air where pest control device 100 is placed by allowing air flow through the chamber of pest control device 100. In one or more embodiments, vent openings 130-132 are positioned to provide omnidirectional release of the volatile compounds in the attractant. Embodiments of the device comprise vent openings 130-132 arranged in a grid over substantially all surfaces of chamber wall 102, maximizing omnidirectional release of volatile compounds through vent openings 130-132. Alternatively, vent openings 130-132 are positioned to provide selective directional release of the volatile compounds in the attractant.

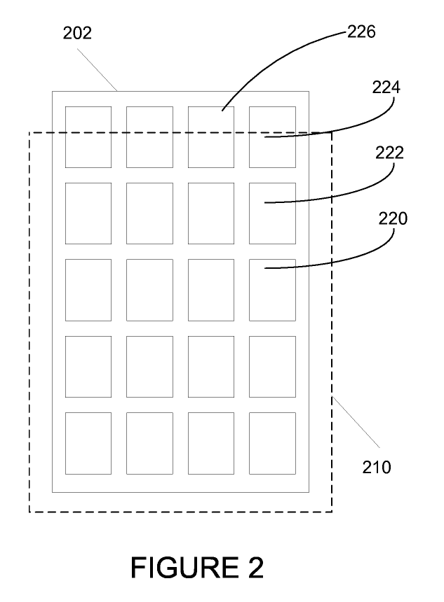

A pesticide layer is affixed to a surface of a treated portion of chamber wall 102. The pesticide layer is applied by spraying, painting, immersion, or any other method capable of coating a treated portion of chamber wall 102. FIG. 2 presents a side view of a chamber wall of a pest control device in accordance with one or more embodiments of the invention. Chamber wall 202 comprises vent openings 220-224. In one or more embodiments, vent openings 220-224 are rectangular openings arranged in a grid. Alternatively, the shape, size and position of vent openings 220-224 are any shape, size and position which provide air flow through the chamber of the pest control device. In one or more embodiments of the device described in this disclosure, the size and shape of vent openings 220-204 are uniform. Alternatively, chamber wall 202 has vent openings of multiple sizes and/or shapes.

The treated portion 210 of chamber wall 202 includes at least one vent opening. The size of vent openings 220-224 are based on the size and behavior of a target insect pest species. Vent openings 220-224 are sized such that a target insect pest species cannot easily pass through without landing on or touching a surface of chamber wall 202. In one or more embodiments, substantially all of pest control device 100 is treated, including surfaces of components other than chamber wall 202. In other instances substantially all of the area of chamber wall 202 comprising vent openings 220-224 is treated. The pesticide layer comprises at least one non-repellent contact pesticide. For instance, the pesticide layer may comprise at least one pesticide selected from Rynaxypyr®, Altocorg, Spinetoram®, Novaluron®, or any other insecticide effective against a target insect such as the codling moth or the navel orangeworm. The pest control device is configured to provide long-term effective period ranging from at least 1-12 months. A residual killing effect may be present after the effective period.

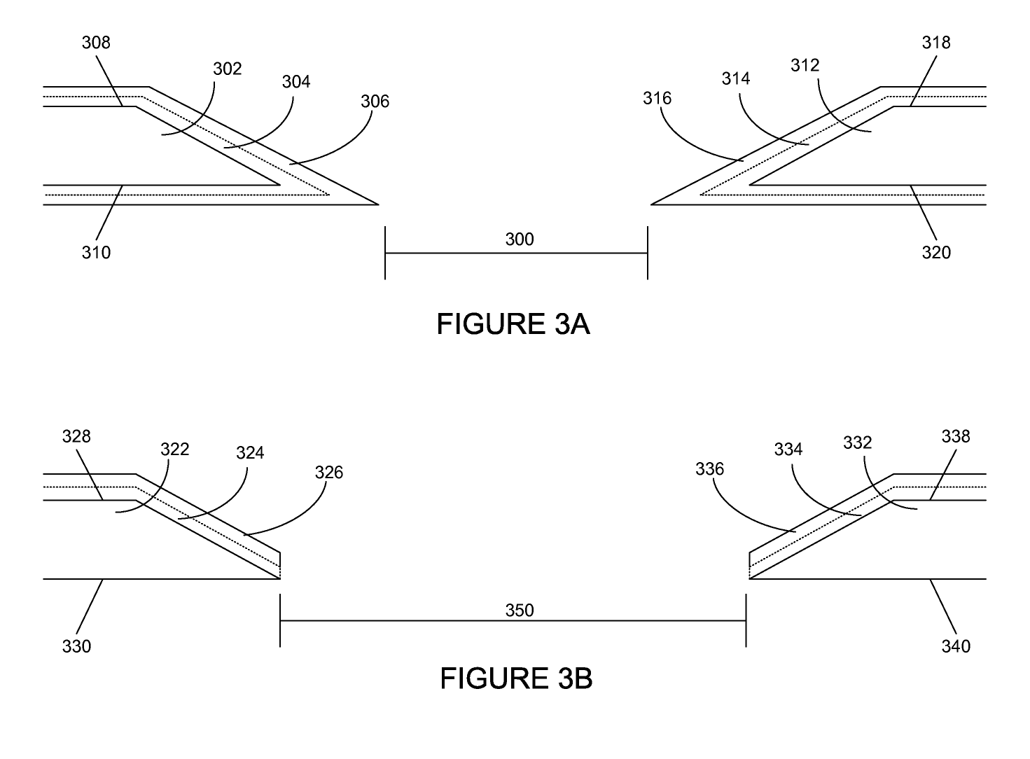

In one configuration of the device an adhesive layer positioned between the treated surface of chamber wall 102 and pesticide layer is used to affix the pesticide layer to the treated portion. FIG. 3A presents a cross section view of a vent opening in a treated portion of chamber wall 102 in one possible configuration, where the treated portion is treated on multiple surfaces. Vent opening 300 of chamber wall 102 is bordered by vent opening edges 302 and 312. Pesticide layers 306 and 316 are affixed to both the outer surfaces 308 and 318 and inner surfaces 310 and 320 of vent opening edges 302 and 312. In one or more embodiments, pesticide layers 306 and 316 are affixed to vent opening edges 302 and 312 using adhesive layers 304 and 314. Vent opening edges 302 and 312 are beveled to provide sloped surfaces to which pesticide layers 306 and 316 are affixed. Alternatively, vent openings are perpendicular or at any other angle or curve relative to the surface of chamber wall 102.

FIG. 3B presents a cross section view of a vent opening in a treated portion of a chamber wall in one or more embodiments of the invention, where the treated portion is treated on one surface. Vent opening 350 is bordered by vent opening edges 322 and 332. Pesticide layers 326 and 336 are affixed to both the outer surfaces 328 of vent opening edges 322 and 332. Pesticide layers 326 and 336 are affixed to vent opening edges 322 and 332 using adhesive layers 324 and 334. Vent opening edges 322 and 332 are beveled to provide sloped surfaces to which pesticide layers 326 and 336 are affixed. Alternatively, vent openings are perpendicular or at any other angle or curve relative to the surface of chamber wall 102.

Adhesive layers 304, 314, 324 and 334 are applied by spraying, painting, immersion, rolling, or any other method capable of coating a treated portion of chamber wall 102 with a liquid or solid adhesive layer. Alternatively, at least one of pesticide layers 306, 316, 326 and 336 is affixed directly to the surface of a treated portion of chamber wall 102 without the use of adhesive layers 304, 314, 324 and 334. In one or more embodiments, a pesticide layer comprises both an adhesive and a pesticide in a single liquid or solid pesticide layer applied to the treated portion of chamber wall 102.

The size and shape of vent openings 300 and 350 is selected such that the application of any adhesive or pesticide layer does not result in obstructed airflow through vent openings 300 and 350 into the pest control device chamber. The thickness of any adhesive layer and pesticide layer is taken into account in manufacturing vent openings 300 and 350. An adhesive layer and pesticide layer is applied to multiple areas of chamber wall 102. The size of vent openings 300 and 350 is based on the size and behavior of a target insect pest species. The idea being that the size of the vent openings being such that a target insect pest species cannot easily pass through vent openings 300 and 350 without landing on or touching a surface of a treated portion of chamber wall 102.

Returning to FIG. 1, surface topographies 120-121 are located on an outer surface of chamber wall 102. Surface topographies 120-121 simulate a surface where an insect pest might preferably lay eggs, providing an ovipositional cue for landing. Surface topographies 120-121 have a surface texture such as a crosshatch pattern, grooves or ridges which simulate a natural egg laying surface for a target insect pest species. Any combination or orientation of grooves, ridges, cross-hatch patterns, or any other two dimensional surface topography that will simulate a natural egg laying surface is in keeping with the spirit of the invention. In one or more exemplary embodiments, the target insect pest species is the navel orangeworm and surface topographies 120-121 simulate a hull or shell split. The surface topographies are not required however and in other embodiments, pest control device 100 is not configured to induce egg laying and does not have any surface topographies.

Embodiments of pest control device 100 are designed to be utilized with a semiochemical ovipositional bait attractant which encourages a target insect pest to lay its eggs on pest control device 100. The texture, shape, orientation, location and other attributes of surface topographies 120-121 are selected to induce a target insect pest species to lay eggs on surface topographies 120-121. The pesticide layer of the pest control device 100 can be applied to surface topographies 120-121. When the pesticide layer comprises a fast acting contact pesticide, mated female target pests expire before laying their eggs, interrupting the reproductive cycle of the target pest population. Alternatively, the pesticide layer comprises a contact pesticide which is slow acting such that the eggs are laid before the female target pest expires, allowing for monitoring of the target pest population using egg count data gathered by examining the pest control device. The action of the pesticide layer is based on the selection of contact pesticides used, the concentration of each contact pesticide used, and any additional compounds added to the pesticide layer. The Surface topographies 120-121 are formed on chamber wall 102 through an injection molding process, through a machining or milling process, through an etching process, through an engraving process, or through any process that results in a surface with the desired texture and shape. The surface topographies can be located on any surface of pest control device 100.

Pest control device 100 is configurable to attract two or more target insect pest species. Modifications to pest control device 100 to attract two or more target insect pest species include the size, texture and location of any surface topographies, the presence of multiple semiochemical attractants in the lure, the size and location of the vent openings, the shape and color of the chamber wall, the types of pesticide, the location of the treated surfaces, and any other modification. In one embodiment of the invention pest control device 100 is configured to attract male codling moth and to induce female navel orangeworm to lay eggs on at least one surface topography.

A bottom end-cap 161 seals a bottom end of pest control device 100. A top end-cap 160 seals the top end of pest control device 100. At least one of end-caps 160-161 is removable. The removable end-cap is attached to the chamber through a compression fit, threads, tape, a mechanical fastener, an elastic band, or any other attachment method that provides for a detachable coupling. Surface topographies are located on surfaces other than a surface of chamber wall 120, such as surface topography 150, located on end cap 160. End caps 160-161 are substituted with any means for sealing the top and bottom of pest control device 100. In one or more configurations, separate end-caps are not necessary as chamber wall sections 1 90a and l 90b are formed to include a top and bottom surface perpendicular to the length or longitudinal axis of the chamber of pest control device 100. End caps 160-161 may comprise additional vent holes to facilitate omnidirectional release of volatile compounds in the attractant.

Hanger 170 is configured to support the pest control device 100 from a physical structure, such as a tree branch, a pole, a building, a line, a wire, or any other physical structure. The hanger can be made of plastic, metal, carbon fiber, cardboard, fiberglass, or any other durable material that is sufficient to support the pest control device 100. Hanger 170 is coupled with top end-cap 160 but can be coupled elsewhere provides that adequate support is provided for the device. In one possible device configuration hanger 170 and top end-cap 160 are a one-piece assembly formed through an injection molding process or through a machining or milling process. In cases where end-cap 160 is not present or in cases where couple hanger 170 to the end cap is not desired, hanger 170 may be coupled to a chamber wall section.

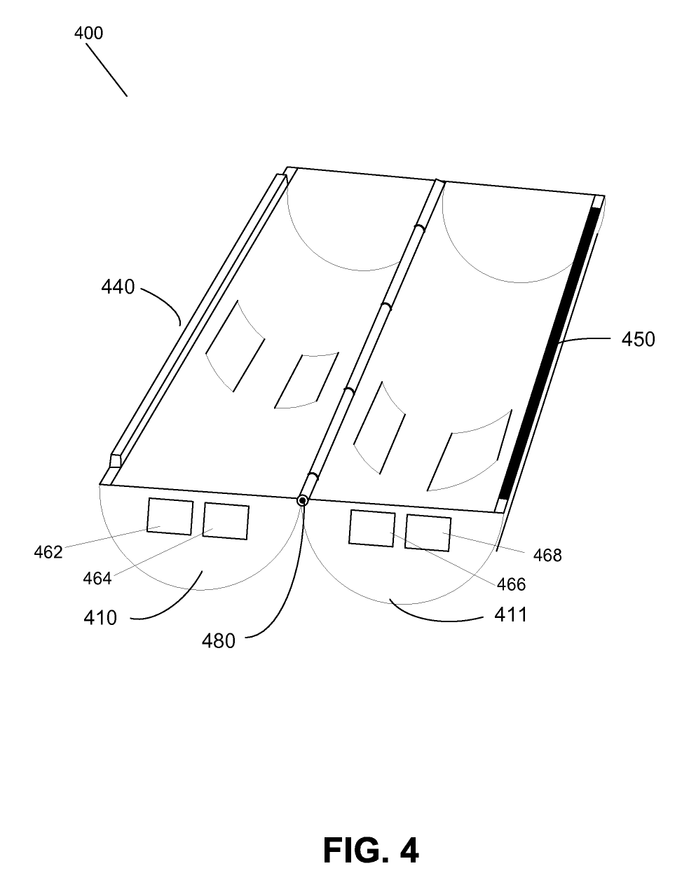

FIG. 4 presents a perspective view of an attract and kill pest control device with a chamber wall comprising two or more chamber wall sections. Chamber wall sections 410 and 411 couple to form the chamber of pest control device 400. Chamber wall sections 410-411 are detachably coupled so that the chamber of pest control device 400 opens for placing a lure comprising a semiochemical attractant, maintenance, cleaning, or inspection of collected target insect pests. A tongue 440 and groove 450 serve as the means for detachably coupling chamber wall section 410 to chamber wall section 411. Tongue 440 and groove 450 are formed as an integral part of chamber wall sections 410-411, such as through an injection molding process, or through a milling or machining process. Alternatively, tongue 440 and groove 450 are separately manufactured components coupled to chamber wall sections 410-411.

Chamber wall section 410 rotates about hinge 480 so that the tongue 440 is automatically aligned with groove 450. Hinge 480 is replaced with another tongue and groove mechanism such that chamber wall sections 410 and 411 completely separate for placing a lure comprising a semiochemical attractant, maintenance, cleaning, or inspection of collected target insect pests. Tongue 440 and grove 450 configured to automatically lock and hold chamber wall section 410 and 411 together securely, coming apart with applied pressure. An additional locking mechanism, such as a clasp, tie, adhesive, pin, or any other locking mechanism, is used to further secure chamber wall section 410 to chamber wall section 411. Vent openings 462-468 are present on the top and bottom surfaces of the chamber wall sections 410 and 411.

It will be apparent to one of ordinary skill in the art that the pest control device described herein may be practiced using other means for detachably coupling chamber wall section 410 and 411 such that the chamber of pest control device 400 opens for placing a lure comprising a semiochemical attractant, maintenance, cleaning, or inspection of collected target insect pests. Examples of detachable coupling means include pins and blind holes, hinges, mechanical fasteners, tape, elastic bands, or the like.

### EXAMPLE 1

### Navel Orange Worm Device

The device of example 1 is a cylindrical chamber. The outer surface of the chamber is painted, covered with, or formed from a material that has a dark and less reflective color, such as black, dark green, dark blue, dark brown, and dark indigo. The device is configured to receive a lure comprising an ovipositional navel orangeworm, such as an almond meal and almond oil mixture. The device attracts female navel orangeworm and has surface topographies coated with a pesticide layer. Vent openings are sized to make it difficult for an adult moth with an average wingspan of 2 cm to enter the device without making contact with a pesticide layer which is affixed the outer surface of the device.

### EXAMPLE 2

### Codling Moth Device

The device of example 2 is a cylindrical chamber. The outer surface of the chamber is painted, covered with, or formed from an orange-colored material. The device is configured to receive a lure comprising a synthetic female codling hormone to attract male codling moth, such as E,E-8,10 Dodecadien-1-ol. The device has no surface topographies. Vent openings are sized to make it difficult for an adult moth with an average wingspan of 1.8 cm to enter the device without making contact with a pesticide layer which is affixed the outer surface of the device.

While the invention herein disclosed has been described by way of examples given through the recitation of of specific embodiments and applications thereof, numerous modifications and variations could be made thereto by those skilled in the art without departing from the scope of the invention set forth in the claims.

What is claimed is:

1. A pest control device comprising:
a chamber comprising a chamber wall, said chamber wall comprising a plurality of vent openings, wherein said chamber is configured to receive a lure comprising a volatile semiochemical attractant and said plurality of vent openings is configured to allow airflow through said chamber wall and release said volatile semiochemical attractant; and
a pesticide layer affixed to a treated portion of said chamber wall, wherein said treated portion of said chamber wall comprises at least one of said plurality of vent openings.

2. The pest control device of claim 1, further comprising an adhesive layer positioned between said treated portion and said pesticide layer, wherein said pesticide layer is affixed to said treated portion by said adhesive layer.

3. The pest control device of claim 1, wherein said chamber wall comprises a plurality of chamber wall sections, wherein said plurality of chamber wall sections couple detachably to form said chamber wall.

4. The pest control device of claim 1, wherein said chamber is cylindrical.

5. The pest control device of claim 1, wherein said semiochemical attractant is a mating disruption pheromone.

6. The pest control device of claim 5, wherein said semiochemical attractant is a female codling moth sex pheromone.

7. The pest control device of claim 1, wherein said plurality of vent openings is configured for omnidirectional release of said volatile semiochemical attractant.

8. The pest control device of claim 1, wherein said semiochemical attractant is an ovipositional bait attractant.

9. The pest control device of claim 8, wherein said chamber wall further comprises a surface topography on an outer surface of said chamber wall.

10. The pest control device of claim 1, wherein said pest control device is further configured to collect a plurality of target insect pests to monitor a target insect pest population.

11. A pest control device comprising:
a chamber comprising at least one chamber wall section, wherein at least one of said at least one chamber wall section comprises a plurality of vent openings, wherein said chamber is configured to receive a lure comprising a volatile semiochemical attractant and said plurality of vent openings is configured to allow airflow through said chamber wall and release said volatile semiochemical attractant;
a pesticide layer applied to a surface of a treated portion of said chamber wall as a liquid, said liquid comprising at least one contact pesticide and a liquid adhesive, wherein said treated portion of said chamber wall comprises at least one of said plurality of vent openings.

12. The pest control device of claim 11, wherein said semiochemical attractant is a mating disruption pheromone.

13. The pest control device of claim 12, wherein said semiochemical attractant is a female codling moth sex pheromone.

14. The pest control device of claim 11, wherein said plurality of vent openings is configured for omnidirectional release of said volatile semiochemical attractant.

15. The pest control device of claim 11, wherein said chamber is further configured to collect a plurality of target insect pests to monitor a target insect pest population.

16. The pest control device of claim 12, wherein said first plurality of vent openings and said second plurality of vent openings are configured for omnidirectional release of said volatile semiochemical attractant from said cylindrical chamber.

17. A pest control device comprising:
a first half cylindrical section, in which said first half cylindrical section comprises a first plurality of vent openings;
a second half cylindrical section, in which said second half cylindrical section comprises a second plurality of vent openings;
a means for detachably coupling said first half cylindrical section and second half cylindrical section to form a cylindrical chamber;
a means for receiving a lure in said cylindrical chamber, said lure comprising at least one volatile pheremone-based attractant directed toward at least one target insect pest species;
a means for sealing the bottom end of said cylindrical chamber;
a means for sealing the top end of said cylindrical chamber; and
a pesticide layer affixed to a surface of a treated portion of said cylindrical chamber, wherein said treated portion comprises said first plurality of vent openings and said second plurality of vent openings.

18. The pest control device of claim 17, wherein said semiochemical attractant is a mating disruption pheromone.

19. The pest control device of claim 17, wherein said semiochemical attractant is a female codling moth sex pheromone.

20. The pest control device of claim 17, wherein said first plurality of vent openings and said second plurality of vent openings are configured for omnidirectional release of said volatile semiochemical attractant from said cylindrical chamber.
